(19) United States
(12) Patent Application Publication
(10) Pub. No.: US 2015/0160100 A1
(43) Pub. Date: Jun. 11, 2015

(54) METHOD AND DEVICE FOR TESTING A SYSTEM OF ACTUATING A MOVABLE STRUCTURE OF A THRUST REVERSER

(71) Applicant: AIRCELLE, GONFREVILLE L'ORCHER (FR)

(72) Inventors: Hakim MAALIOUNE, ORGEVAL (FR); Rodolphe DENIS, LE HAVRE (FR); Achour DEBIANE, Bussy Saint Georges (FR)

(21) Appl. No.: 14/611,646

(22) Filed: Feb. 2, 2015

Related U.S. Application Data
(63) Continuation of application No. PCT/FR2013/051905, filed on Aug. 7, 2013.

(30) Foreign Application Priority Data
Aug. 31, 2012 (FR) 12/58129

(51) Int. Cl. G01M 99/00; G01L 5/22

(52) U.S. Cl. CPC G01M 99/007; G01L 5/22

(57) ABSTRACT

A test device for testing an actuating system for a thrust reverser includes a test bench, an input device, controllers and several determination components. The thrust reverser includes actuating cylinders, and the test bench includes a test structure which has counter-thrust cylinders connected to the actuating cylinders to be tested. Input parameters corresponding to external forces could be entered by the input device, and a first determination component determines a digital model of a movable structure of the thrust reverser. In addition, a second determination component determines force to be exerted by the counter-thrust cylinders by using the digital model and the input parameters. A third determination component determines a control set-point applied to the counter-thrust cylinders, and first and second controllers apply control set-points to counter-thrust and actuating cylinders, respectively. A fourth determination component determines at least one dynamic characteristic of each actuating cylinder.

### CROSS-REFERENCE TO RELATED APPLICATIONS

This application is a continuation of International Application No. PCT/FR2013/051905, filed on Aug. 7, 2013, which claims the benefit of FR 12/58129, filed on Aug. 31, 2012. The disclosures of the above applications are incorporated herein by reference.

### FIELD

The present disclosure relates to a method and a device for testing a system of actuating a movable structure of a thrust reverser.

### BACKGROUND

The statements in this section merely provide background information related to the present disclosure and may not constitute prior art.

An aircraft is driven by several propulsion assemblies each suspended from a fixed structure of the aircraft, for example under a wing or on the fuselage of the aircraft, via a suspension pylon.

Each propulsion assembly comprises a turbojet engine equipped with a fan and an engine, and a nacelle covering the turbojet engine and housing a thrust reverser.

A nacelle generally exhibits a tubular structure comprising an air inlet upstream of the turbojet engine, a mid-section intended to surround the fan of the turbojet engine, a downstream section housing the thrust reverser and intended to surround a combustion chamber and the turbines of the turbojet engine, and is generally terminated with an ejection nozzle the outlet of which is located downstream of the turbojet engine.

A thrust reverser is adapted to improve, during landing of the aircraft, the braking ability thereof by redirecting forward at least a part of the thrust generated by the corresponding turbojet engine. A thrust reverser generally comprises an outer fixed structure called OFS (Outer Fan Structure) and an inner fixed structure called IFS (Inner Fan Structure) which surrounds the engine behind the fan, and a movable structure comprising for example movable cowls. The outer fixed structure comprises in particular an actuating system, generally provided with a plurality of actuating cylinders, arranged to alternately displace the movable structure of the thrust reverser between a closed position in which the movable structure provides an aerodynamic continuity of the corresponding nacelle, and an open position in which at least one passage is uncovered for redirecting forward at least a part of the thrust generated by the corresponding turbojet engine.

In order to provide an optimal operation of such an actuating system in real conditions of use irrespective of the operating conditions of the latter, it is necessary to perform integration tests of this actuating system.

Such integration tests may be carried out using a test device comprising:
a test bench comprising:
a physical structure representative of the movable structure of the thrust reverser and intended to be connected to at least one actuating cylinder of the actuating system to be tested,
at least one test structure including a counter-thrust cylinder connected to the physical structure and intended to be disposed opposite to the at least one actuating cylinder, the at least one counter-thrust cylinder being arranged to simulate external forces applied to the movable structure of the thrust reverser, such as the frictional forces and the aerodynamic forces,
input means arranged to enter input parameters corresponding to the external forces applied to the movable structure of the thrust reverser;
first determination means arranged to determine, for each counter-thrust cylinder, a force to be exerted by said counter-thrust cylinder on the physical structure depending on the input parameters entered beforehand;
second determination means arranged to determine, for each counter-thrust cylinder, a control set-point to be applied to said counter-thrust cylinder depending on the corresponding value of the force to be exerted determined beforehand;
first control means arranged to apply to each counter-thrust cylinder the corresponding control set-point determined beforehand;
second control means arranged to apply to each actuating cylinder a predetermined control set-point;
third determination means arranged to determine at least one dynamic characteristic of each actuating cylinder; and
comparison means arranged to compare the at least one determined dynamic characteristic of each actuating cylinder with a predefined theoretical value.

Such a test device allows simulating, using the physical structure and the at least one test structure, all the external forces likely to be applied to the actuating system to be tested by the movable structure of the thrust reverser in real conditions of use. Furthermore, such a test device allows studying the behavior of the actuating system depending on the simulated operating conditions, and thus validating or not the retained design of the actuating system.

However, the design of such a test device is time-consuming and costly, in particular because of the necessity to realize a physical structure representative of the movable structure of the thrust reverser. Furthermore, such a design is hard to parameter and does not allow reconfiguring the test device in order to be able to take into account, during the development of the movable structure of the thrust reverser, a possible evolution of the latter, and in particular, for example, a modification of the sizing, the stiffness, or even the mass of the movable structure. In such cases, it is necessary to replace the physical structure realized beforehand with a new physical structure representative of the modified movable structure, thereby generating significant additional costs and delays of the tests to be performed.

### SUMMARY

The present disclosure provides a test method and a test device which allow validating, easily and at lower costs, the design of an actuating system of movable structure of a thrust reverser irrespective of the retained design of the movable structure.

The present disclosure provides a method for testing a system of actuating a movable structure of a thrust reverser, comprising the following steps:
having an actuating system to be tested comprising at least one actuating cylinder;
having a test bench comprising at least one test structure including a counter-thrust cylinder;
connecting each actuating cylinder to at least one counter-thrust cylinder, the connected actuating cylinders and counter-thrust cylinders being disposed opposite to each other;
defining input parameters corresponding to external forces applied to the movable structure of the thrust reverser;
determining a digital model of the movable structure of the thrust reverser by taking into account mechanical characteristics, such as static and dynamic mechanical characteristics, of said movable structure of the thrust reverser;
determining, for each counter-thrust cylinder connected to at least one actuating cylinder, a force to be exerted by said counter-thrust cylinder on the associated actuating cylinder so as to simulate or represent the forces applied by the movable structure on the actuating system, the force to be exerted by each counter-thrust cylinder being determined depending on the digital model of the movable structure of the thrust reverser and on the input parameters defined beforehand;
determining, for each counter-thrust cylinder connected to at least one actuating cylinder, a control set-point to be applied to said counter-thrust cylinder depending on the corresponding value of the force to be exerted determined beforehand;
applying to each counter-thrust cylinder the corresponding control set-point determined beforehand;
applying to each actuating cylinder a predetermined control set-point; and determining at least one dynamic characteristic of each actuating cylinder.

By representing the movable structure of the thrust reverser using a digital model of the movable structure and by determining the forces to be exerted by the counter-thrust cylinder(s) depending on this digital model, the test method according to the present disclosure allows simulating all the external forces likely to be applied to the actuating system by the movable structure, and studying the behavior of this actuating system irrespective of the simulated operating conditions, without requiring the realization of a physical structure representative of the movable structure of the thrust reverser.

The test method according to the present disclosure thus allows significantly reducing the duration and the costs of the integration tests of an actuating system.

In addition, the test method according to the present disclosure allows easily taking into account all the evolutions of the movable structure during its development by simply adapting the digital model of the movable structure. These arrangements more significantly reduce the test costs and duration of an actuating system.

Advantageously, the at least one counter-thrust cylinder is arranged to simulate all the external forces applied by the movable structure of the thrust reverser on the actuating system to be tested.

According to one form of the method, the at least one determined dynamic characteristic of each actuating cylinder may for example comprises the velocity or the velocity profile of a movable portion of said actuating cylinder, or even the displacement time of said movable portion between an initial position and a final position.

Each predetermined control set-point applied to the corresponding actuating cylinder is advantageously adapted to control a displacement of said actuating cylinder from an initial position to a final position according to a predetermined velocity profile.

According to another form of the method according to the present disclosure, the digital model of the movable structure of the thrust reverser is determined by realizing a real-time model of the movable structure of the thrust reverser.

According to another form of the method, each actuating cylinder is connected to the counter-thrust cylinder of a different test structure. In other form, at least two actuating cylinders are connected to a same counter- thrust cylinder.

According to another form of the method according to the present disclosure, the force to be exerted by each counter-thrust cylinder connected to at least one actuating cylinder is determined in real-time.

In still another form of the method according to the present disclosure, each test structure further includes connection means, and each actuating cylinder is connected to the at least one associated counter-thrust cylinder via connection means belonging to the corresponding test structure. Such connection means are arranged to mechanically connect the associated actuating cylinders and counter-thrust cylinders, and thus form mechanical connection means. Such connection means are also arranged to physically represent the coupling interface between the movable structure and each actuating cylinder. These arrangements allow facilitating the determination and the validation of the digital model of the movable structure of the thrust reverser, since it is not necessary to model the coupling interface between the movable structure and each actuating cylinder. Such a modeling of the coupling interface can prove to be difficult in particular due to the presence of generally specific clearances and frictions between each actuating cylinder and the movable structure, which are difficult to quantify and model. These mechanical and digital arrangements further allow easily adjusting the test device in case of a modification, during the development of the movable structure of the thrust reverser, of the coupling interface of the movable structure with the actuating cylinders, and this by simply modifying the connection means.

In one form, it is recommended that the test method further comprises a step of having a digital model of the connection means of each test structure taking into account mechanical characteristics of said connection means, the force to be exerted by each counter-thrust cylinder being determined by taking into account moreover the digital model of the corresponding connection means.

The step of determining a force to be exerted by each counter-thrust cylinder advantageously comprises the steps comprising:

calculating, for each counter-thrust cylinder, the force to be exerted by said counter-thrust cylinder on the at least one associated actuating cylinder depending on:
the digital model of the movable structure of the thrust reverser, and
the input parameters defined beforehand,
   correcting each value of the force to be applied calculated beforehand depending on the digital model of the corresponding connection means.

The step of calculating the force to be exerted by each counter-thrust cylinder preferably comprises the step consisting of applying the digital model of the movable structure to the input parameters defined beforehand.

In another form, the mechanical characteristics taken into account for determining the digital model of the connection means of each test structure include at least the stiffness and/or the mass of said connection means. The stiffness and/or the mass of said connection means are for example taken into account in form of stiffness and/or mass matrices.

According to one form of the method, the at least one dynamic characteristic of each actuating cylinder is determined from a measurement of at least one dynamic characteristic of the connection means of the corresponding test structure. The at least one dynamic characteristic of each actuating cylinder is for example determined from a measurement of the velocity and/or the position of the connection means of the corresponding test structure. The at least one dynamic characteristic of each actuating cylinder is for example determined using a position sensor arranged to measure the position of a predetermined portion of the corresponding connection means.

According to another form of the method, the at least one dynamic characteristic of each actuating cylinder is determined from a measurement of the velocity and/or the position of a movable portion of said actuating cylinder.

Advantageously, the connection means of each test structure include at least one carriage mounted movable in translation along a direction substantially parallel to the extension direction of the associated actuating cylinders and counter-thrust cylinders, the at least one carriage being coupled to at least one corresponding actuating cylinder.

In other form, the test method comprises a step of adjusting the coupling stiffness between each actuating cylinder and the at least one corresponding carriage, for example using an appropriate mechanical device. These arrangements allow easily adapting the coupling interface between each actuating cylinder and the corresponding carriage, and hence easily modifying the test device to take into account possible modifications of the movable structure during its development.

According to one form of the method, the digital model of the movable structure of the thrust reverser is further determined by taking into account the at least one dynamic characteristic determined beforehand of each actuating cylinder.

According to another form of the method, the latter comprises a step of determining at least one dynamic characteristic of each counter-thrust cylinder. In other form, the control set-point to be applied to each counter-thrust cylinder is determined by taking into account moreover the at least one dynamic characteristic determined beforehand of said counter-thrust cylinder. The at least one dynamic characteristic determined beforehand of each counter-thrust cylinder may for example comprises the position, the velocity or even the velocity profile of a movable portion of said counter-thrust cylinder. The at least one dynamic characteristic of each counter-thrust cylinder may for example be determined from a measurement of the velocity and/or the position of the connection means of each test structure.

According to one form of the method, the latter comprises a step of determining the actual force exerted by each counter-thrust cylinder on the at least one associated actuating cylinder. The actual force exerted by each counter-thrust cylinder is for example determined using a load sensor associated to each counter-thrust cylinder or to the corresponding connection means.

According to one form of the method, the control set-point to be applied to each counter-thrust cylinder is further determined depending on the determined beforehand actual force exerted by said counter-thrust cylinder.

According to another form of the method, the mechanical characteristics taken into account for the digital model of the movable structure of the thrust reverser include at least the stiffness and/or the mass of the movable structure of the thrust reverser. The stiffness and/or the mass of the movable structure of the thrust reverser are for example taken into account in form of stiffness and/or mass matrices.

In another form, the defined input parameters correspond at least to the frictional forces and aerodynamic forces applied to the movable structure of the thrust reverser.

According to other form of the method, the latter comprises a step of comparing the at least one determined dynamic characteristic of each actuating cylinder with a predefined theoretical value.

In another form, each control set-point to be applied to a counter-thrust cylinder is determined in real-time.

The present disclosure further concerns a device for testing a system of actuating a movable structure of a thrust reverser including at least one actuating cylinder, the test device comprising:
a test bench comprising at least one test structure including at least one counter-thrust cylinder intended to be connected to at least one actuating cylinder of the actuating system to be tested, so that the connected actuating cylinders and counter-thrust cylinders are disposed opposite to each other,
input means arranged to enter input parameters corresponding to external forces applied to the movable structure of the thrust reverser,
first determination means arranged to determine a digital model of the movable structure of the thrust reverser by taking into account mechanical characteristics, such as static and dynamic mechanical characteristics, of the movable structure of the thrust reverser,
second determination means arranged to determine, for each counter-thrust cylinder, a force to be exerted by said counter-thrust cylinder on the at least one associated actuating cylinder so as to simulate or represent the forces applied by the movable structure on the actuating system, the force to be exerted by each counter-thrust cylinder being determined depending on the digital model of the movable structure of the thrust reverser and on the input parameters entered beforehand,
third determination means arranged to determine, for each counter-thrust cylinder, a control set-point to be applied to said counter-thrust cylinder depending on the corresponding value of the force to be exerted determined beforehand,
first control means arranged to apply to each counter-thrust cylinder the corresponding control set-point determined beforehand,
second control means arranged to apply to each actuating cylinder a predetermined control set-point, and
fourth determination means arranged to determine at least one dynamic characteristic of each actuating cylinder.

In one form, each test structure further includes connection means arranged to connect the at least one corresponding counter-thrust cylinder to the at least one associated actuating cylinder of the actuating system to be tested.

Advantageously, the test device includes fifth determination means arranged to determine a digital model of the connection means of each test structure by taking into account mechanical characteristics of said connection means.

In another form, the second determination means are arranged to determine the force to be exerted by each counter-thrust cylinder depending moreover on the digital model of the corresponding connection means.

According to another form of the present disclosure, the fourth determination means comprise means for measuring or calculating the at least one dynamic characteristic of each actuating cylinder.

According to another form of the present disclosure, the test device includes comparison means arranged to compare the at least one determined dynamic characteristic of each actuating cylinder with a predefined theoretical value.

In other form, the first determination means are arranged to determine the digital model of the movable structure of the thrust reverser by taking into account moreover the at least one dynamic characteristic determined beforehand of each actuating cylinder.

According to another form of the present disclosure, the test device includes sixth determination means arranged to determine the actual force exerted by each counter-thrust cylinder on the at least one associated actuating cylinder. The sixth determination means include for example a load sensor associated to each counter-thrust cylinder.

Advantageously, the third determination means are arranged to determine the control set-point to be applied to each counter-thrust cylinder depending moreover on the determined beforehand actual force exerted by said counter-thrust cylinder.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a test device according to the present disclosure; and

FIG. 2 is a schematic view of a test structure of the test device of FIG. 1 connected to an actuating cylinder of an actuating system to be tested.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

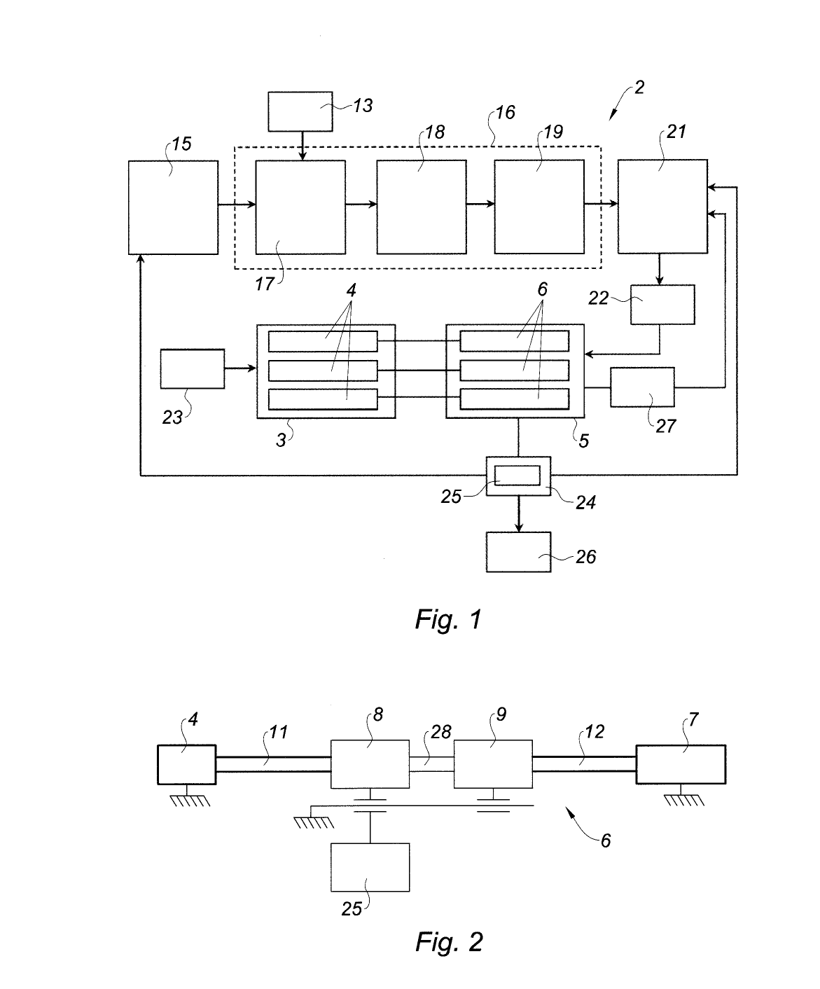

FIGS. 1 and 2 represent a device 2 for testing a system 3 for actuating a movable structure of a thrust reverser of an aircraft. Such an actuating system 3 includes a plurality of actuating cylinders 4 arranged to displace the movable structure of the thrust reverser between closed and open positions.

The test device 2 comprises a test bench 5 comprising a plurality of test structures 6. Each test structure 6 includes a counter-thrust cylinder 7 and connection means arranged to connect said counter-thrust cylinder 7 to an actuating cylinder 4 of the actuating system 3 to be tested, so that the associated actuating cylinders 4 and counter-thrust cylinders 7 are disposed opposite to each other and extend substantially in a parallel manner, and/or in a coaxial manner. Each counter-thrust cylinder may be for example a hydraulic or pneumatic cylinder.

As shown more particularly in FIG. 2, the connection means of each test structure 6 advantageously include first and second carriages 8, 9 integral with each other and mounted movable in translation along a direction substantially parallel to the extension direction of the corresponding actuating cylinders 4 and counter-thrust cylinders 7. The first carriage 8 comprises coupling means arranged to couple the first carriage 8 to the actuating rod 11 of the corresponding actuating cylinder 4. The coupling means of the first carriage 8 could be shaped to represent the real coupling interface between the movable structure of the thrust reverser and the corresponding actuating cylinder 4. The second carriage 9 also comprises coupling means arranged to couple the second carriage 9 to the actuating rod 12 of the corresponding counter-thrust cylinder 7.

The test device 2 further comprises input means, such as data input means 13, arranged to enter input parameters corresponding to external forces applied to the movable structure of the thrust reverser, and in particular corresponding to the frictional forces and the aerodynamic forces applied to the movable structure.

The test device 2 also comprises determination means 15 arranged to determine a digital model of the movable structure of the thrust reverser by taking into account the mechanical characteristics of the movable structure of the thrust reverser, and in particular the stiffness and the mass of the movable structure.

The digital model of the movable structure of the thrust reverser corresponds to a dynamic equation which relates:
the position and the acceleration of the movable structure,
the mechanical characteristics of the movable structure in form of a stiffness matrix and a mass matrix, and
the external forces applied on the movable structure in form of matrices, and in particular:
   the aerodynamic forces,
   the frictional forces, and
   the forces applied by the actuating cylinders 4 of the actuating system 3.

The dynamic equation is the following:

[M]Ü+[K]U=[F_{act}]−[Fₐₑᵣₒ]−[F_{friction}]

wherein [M] and [K] are respectively the mass and the stiffness matrices of the movable structure of the thrust reverser, [F_{act}] is the matrix of the forces applied by the actuating cylinders 4 of the actuating system 3 on the movable structure, [Fₐₑᵣₒ] is the matrix of the aerodynamic forces applied on the movable structure, and [F_{friction}] is the matrix of the frictional forces applied on the movable structure.

The coefficients of the stiffness matrix, as well as the coefficients of the mass matrix of the movable structure may be obtained in particular thanks to a finite element calculation based on a CAD 3D modeling of the movable structure of the thrust reverser.

The coefficients of the matrices of the aerodynamic forces and frictional forces are data entered via the input means 13.

The method for digitally solving the dynamic equation is advantageously adapted to take into account possible convergence problems.

The test device also includes determination means 16 arranged to determine in real-time, for each counter-thrust cylinder 7, a force to be exerted by said counter-thrust cylinder 7 on the associated actuating cylinder 4, so as to simulate the forces applied by the movable structure on the actuating cylinders 4 of the actuating system 3.

The determination means 16 comprise in particular calculation means 17 arranged to calculate, for each counter-thrust cylinder 7, the force to be exerted by said counter-thrust cylinder 7 on the associated actuating cylinder 4 depending on the digital model of the movable structure of the thrust reverser and on the input parameters entered beforehand.

The calculation means 17 are more particularly arranged to:
solve the dynamic equation in order to calculate the matrix [F_{act}], and more particularly calculate the force applied by each actuating cylinder 4 on the movable structure, and
calculate the matrix of the forces to be exerted by the counter-thrust cylinders 7 on the actuating cylinders 4 from the matrix [F_{act}] calculated beforehand, and more particularly calculate the force to be exerted by each counter-thrust cylinder 7 on the corresponding actuating cylinder 4 from the force applied by said actuating cylinder 4 calculated beforehand.

According to the principle of reciprocal actions, the matrix of the forces applied by the actuating cylinders on the movable structure is identical, in absolute value, to the matrix of the forces applied by the movable structure on the actuating cylinders. Yet, since the function of the counter-thrust cylinders 7 is to simulate the forces applied by the movable structure on the actuating cylinders 4 of the actuating system 3, the calculated matrix of the forces to be exerted by the counter-thrust cylinders 7 on the actuating cylinders 4 should also be identical, in absolute value, to the matrix [F_{act}]. Consequently, it is easy to calculate the matrix of the forces to be exerted by the counter-thrust cylinders 7 on the actuating cylinders 4 from the matrix [F_{act}].

The determination means 16 further comprise:
determination means 18 arranged to determine a digital model of the connection means of each test structure 6 by taking into account the mechanical characteristics of said connection means, and in particular the stiffness and the mass of said connection means in form of stiffness and mass matrices, and
correction means 19 arranged to correct the calculated matrix of the forces to be exerted by the counter-thrust cylinders 7 on the actuating cylinders 4 by taking into account the digital models of the connection means, and more particularly to correct each value of the force to be exerted calculated beforehand by taking into account the digital model of the corresponding connection means.

The correction means 19 thus allow anticipating the dynamic effects of the connection means of each test structure 6 on the behavior of the corresponding counter-thrust cylinder 7, and hence providing the application of a force on the corresponding actuating cylinder 4 substantially identical to the value of the force to be exerted calculated beforehand by the calculation means 17.

The coefficients of the stiffness and mass matrices related to the connection means of each test structure 6 may be obtained in particular thanks to a finite element calculation based on a CAD 3D modeling of said connection means.

The test device 2 further includes determination means 21 arranged to determine in real-time, for each counter-thrust cylinder 7, a control set-point to be applied to said counter-thrust cylinder 7 depending on the corresponding value of the force to be exerted determined beforehand, that is to say calculated and corrected beforehand.

The test device 2 includes, in addition, control means 22 arranged to apply to each counter-thrust cylinder 7 the corresponding control set-point determined beforehand, and control means 23 arranged to apply to each actuating cylinder 4 a predetermined control set-point. The predetermined control set-point applied to each actuating cylinder 4 is advantageously adapted to control a displacement of the corresponding actuating cylinder 4 from an initial position to a final position according to a predetermined velocity profile.

The test device 2 also includes determination means 24 arranged to determine at least one dynamic characteristic of each actuating cylinder 4, such as the position and/or the velocity of the actuating rod 11 of said actuating cylinder 4. The determination means 24 advantageously include measuring or calculation means 25 arranged to measure or calculate the position and/or the velocity of the actuating rod 11 of each actuating cylinder 4.

According to one form of the present disclosure, the measuring or the calculation means 25 include a plurality of position sensors each associated to one test structure 6 and each arranged to measure the position of a predetermined portion of the connection means of the associated test structure 6. The position of each actuating cylinder 4 is then determined from the position measurement performed by the corresponding position sensor.

According to another form of the present disclosure, the measuring or the calculation means 25 include a plurality of position sensors each associated to one actuating cylinder 4 and each arranged to measure the position of the actuating rod 11 of the associated actuating cylinder 4.

According to other form of the present disclosure, the determination means 24 are arranged to determine at least one dynamic characteristic of each counter-thrust cylinder 7, such as the position, the velocity or even the velocity profile of a movable portion of said counter-thrust cylinder. The dynamic characteristic(s) of each counter-thrust cylinder 7 may for example be determined from a measurement of the position of the connection means of the corresponding test structure 6 or from a measurement of the position of the movable portion of the corresponding actuating cylinder 4, this because each counter-thrust cylinder 7 is integral in translation with the corresponding connection means and with the associated actuating cylinder 4.

The test device 2 includes, in addition, comparison means 26 arranged to compare the dynamic characteristic(s) determined for each actuating cylinder 4 with one or several expected predefined theoretical value(s) depending on the control set-point applied to said actuating cylinder 4. The comparison means 26 thus allow comparing for example the measured velocity profile and the measured instantaneous position of each actuating cylinder 4 with the expected velocity profile and the expected instantaneous position, and thereby validating or not the design of the actuating system.

In one form, the determination means 15 are arranged to determine the digital model of the movable structure of the thrust reverser by further taking into account the position of each actuating cylinder 4 determined by the determination means 24. More particularly, the determination means 15 are arranged to adapt the coefficients of the stiffness matrix of the movable structure depending on the position of each actuating cylinder 4. These arrangements allow taking into account the fact that the stiffness of the movable structure varies depending on the position of the latter, and hence improving the definition of the digital model of the movable structure.

According to another form of the present disclosure, the test device 2 also includes determination means 27 arranged to determine the actual force exerted by each counter-thrust cylinder 7 on the associated actuating cylinder 4. The determination means 27 include, for example, a load sensor 28 associated to each counter-thrust cylinder 7, and disposed, for example, between the two carriages 8, 9.

Advantageously, the determination means 21 are arranged to determine the control set-point to be applied to each counter-thrust cylinder 7 depending moreover on the actual force exerted by said counter-thrust cylinder 7 determined using the determination means 27. These arrangements allow, if necessary, readjusting the control set-point applied to a counter-thrust cylinder 7, so that the force exerted by the latter on the corresponding actuating cylinder 4 substantially corresponds to the force calculated by the calculation means 17.

According to one form of the present disclosure, the test device 2 comprises one or several microprocessor(s) arranged to control the different determination, comparison, control and calculation means.

A method for testing a system 3 for actuating a movable structure of a thrust reverser using a test device 2 according to the present disclosure will be now described.

Such a test method comprises the following steps: connecting each actuating cylinder 4 to the counter-thrust cylinder 7 of a different test structure 6 via the corresponding connection means, the connected actuating cylinders 4 and counter-thrust cylinders 7 being disposed opposite to each other,
entering input parameters corresponding to the frictional forces and to the aerodynamic forces applied to the movable structure of the thrust reverser using the input means 13,
determining the digital model of the movable structure of the thrust reverser using the determination means 15,
determining a digital model of the connection means of each test structure 6 using the determination means 18,
determining in real-time, for each counter-thrust cylinder 7, a force to be exerted by said counter-thrust cylinder 7 on the associated actuating cylinder 4 using the determination means 16,
determining in real-time, for each counter-thrust cylinder 7, a control set-point to be applied to said counter-thrust cylinder 7 using the determination means 21,
applying to each counter-thrust cylinder 7 the corresponding control set-point determined beforehand using the control means 22,
applying to each actuating cylinder 4 a predetermined control set-point using the control means 23,
determining one or several dynamic characteristic(s) of each actuating cylinder 4, such as for example the position or the velocity of a movable portion of said actuating cylinder 4, using the determination means 24,
comparing the determined dynamic characteristic(s) of each actuating cylinder 4 with an expected predefined theoretical value using the comparison means 26,
validating or not the design of the tested actuating system 3 depending on the performed comparisons.

Advantageously, the test method further comprises the following steps:
taking into account the position of the movable portion of each actuating cylinder 4 to determine the digital model of the movable structure of the thrust reverser,
determining one or several dynamic characteristic(s) of each counter-thrust cylinder 7, such as the position or the velocity of a movable portion of said counter-thrust cylinder 7, using the determination means 24,
determining the actual force exerted by each counter-thrust cylinder 7 on the associated actuating cylinder 4 using the determination means 27,
taking into account the actual force exerted by each counter-thrust cylinder 7 and the dynamic characteristic(s) determined beforehand for each counter-thrust cylinder 7 in order to determine the control set-point to be applied to each counter-thrust cylinder 7.

It goes without saying that the present disclosure is not limited to the sole form of this test device and to the sole alternative implementations of the test method, described above by way of examples, it encompasses on the contrary all the alternative forms thereof.

What is claimed is:

1. A method for testing a system of actuating a movable structure of a thrust reverser, comprising:
having an actuating system to be tested comprising at least one actuating cylinder;
having a test bench comprising at least one test structure comprising at least one counter-thrust cylinder;
connecting said at least one actuating cylinder to said at least one counter-thrust cylinder, the connected actuating cylinders and counter-thrust cylinders being disposed opposite to each other;
determining a digital model of the movable structure of the thrust reverser by taking into account mechanical characteristics of the movable structure of the thrust reverser;
defining input parameters corresponding to external forces applied to the movable structure of the thrust reverser;
determining, for each of said at least one counter-thrust cylinder connected to said at least one actuating cylinder, a force to be exerted by said at least one counter-thrust cylinder on said at least one actuating cylinder so as to simulate or represent forces applied by the movable structure on the system, the force to be exerted by said at least one counter-thrust cylinder being determined depending on the digital model of the movable structure of the thrust reverser and on the input parameters defined beforehand;
determining, for said at least one counter-thrust cylinder connected to said at least one actuating cylinder, a control set-point to be applied to said at least one counter-thrust cylinder depending on the corresponding value of the force to be exerted determined beforehand;
applying to each of said at least one counter-thrust cylinder the corresponding control set-point determined beforehand;
applying to each of said at least one actuating cylinder a predetermined control set-point; and
determining at least one dynamic characteristic of each of said at least one actuating cylinder.

2. The test method according to claim 1, wherein said at least one test structure further comprises connection means, and wherein each of said at least one actuating cylinder is connected to said at least one corresponding counter-thrust cylinder via the connection means belonging to the corresponding test structure.

3. The test method according to claim 2, further comprising a step of having a digital model of the connection means of the test structure taking into account mechanical characteristics of the connection means, wherein the force to be exerted by said at least one counter-thrust cylinder is determined by taking into account the digital model of the connection means.

4. The test method according to claim 3, wherein the mechanical characteristics of the connection means of the test structure include at least one of a stiffness and a mass of the connection means.

5. The test method according to claim 2, wherein said at least one dynamic characteristic of each of said at least one actuating cylinder is determined from a measurement of at least one dynamic characteristic of the connection means of the test structure.

6. The test method according to claim 5, wherein said at least one dynamic characteristic of each of said at least one actuating cylinder is determined from a measurement of at least one of velocity and position of the connection means of the test structure.

7. The test method according to claim 2, wherein the connection means of the test structure comprises at least one carriage mounted movable in translation along a direction substantially parallel to an extension direction of said at least one actuating and counter-thrust cylinders, said at least one carriage being coupled to said at least one actuating cylinder.

8. The test method according to claim 7, further comprising a step of adjusting a coupling stiffness between each of said at least one actuating cylinder and said at least one corresponding carriage.

9. The test method according to claim 1, wherein the digital model of the movable structure is determined by further taking into account said at least one dynamic characteristic determined beforehand of each actuating cylinder.

10. The test method according to claim 1, further comprising a step of determining at least one dynamic characteristic of each of said at least one counter-thrust cylinder.

11. The test method according to claim 10, wherein the control set-point to be applied to said at least one counter-thrust cylinder is further determined by taking into account said at least one dynamic characteristic determined beforehand of said at least one counter-thrust cylinder.

12. The test method according to claim 1, further comprising a step of determining an actual force exerted by said at least one counter-thrust cylinder on said at least one corresponding actuating cylinder.

13. The test method according to claim 12, wherein the control set-point to be applied to each of said at least one counter-thrust cylinder is further determined depending on the actual force exerted by said at least one counter-thrust cylinder.

14. The test method according to claim 1, wherein the mechanical characteristics of the movable structure comprises at least one of a stiffness and a mass of the movable structure of the thrust reverser.

15. The test method according to claim 1, wherein the input parameters correspond to at least one of frictional forces and aerodynamic forces applied to the movable structure of the thrust reverser.

16. The test method according to claim 1, further comprising a step of comparing said at least one determined dynamic characteristic of said at least one actuating cylinder with a predefined theoretical value.

17. A test device for testing a system for actuating a movable structure of a thrust reverser comprising at least one actuating cylinder, the test device comprising:
a test bench comprising at least one test structure comprising at least one counter-thrust cylinder connected to at least one actuating cylinder of the system to be tested, so that said at least one actuating and counter-thrust cylinders are disposed opposite to each other;
input means configured to enter input parameters corresponding to external forces applied to the movable structure of the thrust reverser;
first determination means configured to determine a digital model of the movable structure of the thrust reverser by mechanical characteristics of the movable structure of the thrust reverser;
second determination means configured to determine, for each of said at least one counter-thrust cylinder, a force to be exerted by said at least one counter-thrust cylinder on said at least one corresponding actuating cylinder so as to simulate or represent forces applied by the movable structure on the system, the force to be exerted by each of said at least one counter-thrust cylinder being determined depending on the digital model of the movable structure of the thrust reverser and on the input parameters entered beforehand;
third determination means configured to determine, for each of said at least one counter-thrust cylinder, a control set-point to be applied to said at least one counter-thrust cylinder depending on the corresponding value of the force to be exerted determined beforehand;
first control means configured to apply to each of said at least one counter-thrust cylinder the corresponding control set-point determined beforehand;
second control means configured to apply to each of said at least one actuating cylinder a predetermined control set-point; and
fourth determination means configured to determine at least one dynamic characteristic of each of said at least one actuating cylinder.
